(19) United States
(12) Patent Application Publication
(10) Pub. No.: US 2025/0111308 A1
(43) Pub. Date: Apr. 3, 2025

(54) WORKFORCE SCHEDULING BASED ON PROBLEM DECOMPOSITION

(71) Applicant: UKG Inc., Weston, FL (US)

(72) Inventors: Ahmed Hadjar, Laval (CA); Beyime Tachefine, Montreal (CA); Francois Lessard, Sherbrooke (CA); Larissa Terra-Muzeau, Montreal (CA); Pierre Montulet, Montreal (CA); Regis Sahore Drogba, Montreal (CA); Sylvie Gelinas, Sainte-Thérèse (CA)

(21) Appl. No.: 18/812,472

(22) Filed: Aug. 22, 2024

Related U.S. Application Data
(60) Provisional application No. 63/541,440, filed on Sep. 29, 2023.

(51) Int. Cl. G06Q 10/0631; G06Q 10/1093

(52) U.S. Cl. CPC G06Q 10/06312; G06Q 10/1097

(57) ABSTRACT

An example method of workforce scheduling includes: identifying a plurality of variables associated with scheduling a plurality of workers to perform a plurality of jobs during a plurality of time periods; identifying a principal scheduling problem for optimizing a principal objective function defined on a principal subset of a plurality of variables subject to a principal subset of a plurality of constraints; determining a tentative solution of the principal scheduling problem; identifying one or more sub-problems, each associated with a subset of constraints that are not satisfied by a tentative schedule defined by the tentative solution; identifying, by solving the one or more sub-problems, one or more candidate variables improving a value of the principal objective function; modifying the principal scheduling problem by appending the candidate variables to the principal scheduling problem; and generating a schedule by solving the modified principal scheduling problem.

### REFERENCE TO RELATED APPLICATIONS

This application claims the benefit of U.S. Provisional Application No. 63/541,440, filed Sep. 29, 2023, which is incorporated by reference herein.

### TECHNICAL FIELD

Embodiments of the present disclosure relate to computing systems, and more specifically, to methods and systems for workforce scheduling.

### BACKGROUND

Successful functioning of an organization (e.g., an enterprise, such as a manufacturing company, a retail company, or a service provider) depends on its ability to perform efficient scheduling, i.e., assignment of jobs to workers (including employees, temporary workers, independent contractors, and/or other categories of workforce) during specified time periods (“shifts”). The scheduling problem is a nondeterministic polynomial-time hard (NP-hard) optimization problem.

### BRIEF DESCRIPTION OF THE DRAWINGS

The disclosure is illustrated by way of example, and not by way of limitation, and may be more fully understood with references to the following detailed description when considered in connection with the figures, in which:

FIG. 1 schematically illustrates an example scheduling problem represented in a form solvable by the systems and methods of the present disclosure.

FIG. 2 depicts a flow diagram of an example workflow 200 of solving a workforce scheduling problem by decomposition, in accordance with aspects of the present disclosure.

FIG. 3 depicts a flow diagram of an example method of generating a workforce schedule by decomposition of the original scheduling problem, in accordance with aspects of the present disclosure.

FIG. 4 schematically illustrates a high-level diagram of an example distributed computer system, which may implement the methods described herein.

FIG. 5 is a block diagram illustrating a computing system in which implementations of the disclosure may be used.

### DETAILED DESCRIPTION

Successful functioning of an organization (e.g., an enterprise, such as a manufacturing company, a retail company, or a service provider) depends on its ability to perform efficient scheduling, i.e., assignment of jobs to workers (including employees, temporary workers, independent contractors, and/or other categories of workforce) during specified time periods (“shifts”). Various approaches to scheduling result in nondeterministic polynomial-time hard (NP-hard) optimization problems. Starting from a certain dimensionality of the problem, not only the brute force approach but also various more efficient mathematical programming approaches would result in a prohibitively large computational resource consumption and/or time required to yield even a suboptimal solution.

To address the above-noted and other deficiencies of various scheduling problem solutions, the systems and methods of the present disclosure implement several heuristic approaches which result in substantially better performance, thus allowing efficient generation of workforce schedules for large-scale scenarios (e.g., the number of workers and/or the number of jobs exceeding respective predefined thresholds, such as 1000 workers and/or 100 jobs. The techniques described herein may be used in various workforce management applications.

“Schedule” herein broadly refers to a data structure specifying allocation of resources to jobs during specified time periods (“shifts”). Resources may include, e.g., human resources (workers), equipment, and/or materials. Thus, in some implementations, a schedule may be represented by a finite set of n-tuples <shift-idᵢ, job-idⱼ, resource-idₖ, . . . >, where Shift-id is an identifier of the shift, which may be represented by the shift start time and the shift end time, the shift start time and the shift duration, the shift sequential number (such as an index in a chronologically ordered reference list of shifts) or any other suitable identifying information; Job-id is an identifier of the job, which may be represented by an index in a reference list of jobs or any other suitable identifying information; and resource-id is an identifier of a resource (e.g., a worker, such as an employee, a temporary worker, an independent contractor, a volunteer, etc.). A tuple <shift-idᵢ, job-idⱼ, resource-idₖ> means that the resource identified by resource-idₖ has been assigned to perform the job identified by job-idⱼ during the shift identified by the shift-idᵢ. In some implementations, job-idⱼ may be represented by a list of job identifiers, thus allowing to schedule multi-job shifts.

While the schedules in the examples described herein are based on 3-tuples that include the shift identifier, the job identifier, and the resource identifier, in various other implementations the schedule-forming tuples may include a different number of elements. In some implementations, a schedule may be visually rendered by a rectangular table, the columns of which correspond to shifts (e.g., identified by the start date/time and end date/time) and the rows of which correspond to workers. A cell of such a table may store an identifier of a job assigned to the worker associated with the row during the shift associated with the column. In various other implementations, other data structures may be involved for storing and/or visually rendering schedules generated by systems and methods of the present disclosure.

In an illustrative example, the scheduling problem may be represented as a mixed integer linear programming (MILP) problem, which may be formally defined as follows:
Minimize z=c^{T} x subject to Ax=b, x≥0, x∈ [symbol] ⁿ for at least some xᵢ [symbol]
where z is the objective function (e.g., based on a chosen quality metric characterizing, e.g., the job coverage and the worker satisfaction);
b and c are vectors of real numbers (c∈ [symbol] ⁿ, b∈ [symbol] ^{m}); and
A is a matrix of real numbers (A∈ [symbol] ^{m×n}); and
[symbol] ⁿ is a n-dimensional integer space.

The decision variables may represent worker assignments to particular jobs during particular shifts. The constraints may represent various applicable scheduling rules. The objective function may reflect the overall quality of the schedule and may be composed by a set of additive terms representing respective soft constraints derived from applicable scheduling rules.

Techniques for solving the scheduling problem may be chosen based on its dimensionality (e.g., defined by the number of workers, the number of jobs, and/or the timespan to be scheduled). In some implementations, if the dimensionality of the scheduling problem exceeds a predefined threshold, the scheduling problem may be broken down into multiple sub-problems (e.g., the principal problem and a set of sub-problems). The threshold dimensionality for choosing the shift enumeration technique may be determined to satisfy relevant resource and time-based criteria.

Thus, in order to reduce the computational complexity, such a MILP problem may be broken down into the principal problem and a set of sub-problems. The reduced dimensionality of the resulting principal problem allows solving it using various mathematical programming methods (e.g., the simplex method). Furthermore, the sub-problems may be solved simultaneously (e.g., by assigning a respective dedicated execution environment, such as a process, a processing thread, a virtual or a physical machine, to each of the sub-problems), thus further reducing the overall time that would be necessary to find an acceptable solution.

The principal problem may be defined on a subset of decision variables representing respective worker schedules of the original scheduling problem. The subset of constraints for the principal problem may be formed by global constraints, i.e., the constraints that are applicable to all workers and/or all time periods being scheduled. Due to its reduced dimensionality, the principal problem may, at each iteration, be solved as a MILP problem, e.g., by applying one or more mathematical programming techniques. The resulting solution of the principal problem may be analyzed to identify one or more sub-schedules to be improved by respective one or more sub-problems. “Sub-schedule” herein shall refer to any subset of the original schedule, which may be defined, e.g., by any combination of at least a subset of time periods of the original schedule, at least a subset of workers of the original schedule, and at least a subset of jobs of the original schedule. In an illustrative example, a sub-schedule may be defined based on a chosen grouping criterion (e.g., a combination of organizational boundaries, geographic boundaries, job categories, time periods, etc.). In another illustrative example, a sub-schedule may be represented by a subset of the original schedule limited to a subset of workers.

Thus, each sub-problem may be defined by identifying, within the current solution of the principal problem, one or more suboptimalities, represented by one or more global constraints and objectives that are not satisfied by the initial or intermediate solution of the principal problem, may be identified in the current solution. Examples of such constraints include worker-centric scheduling rules, worker preferences, worker schedule stability, etc.

Multiple sub-problems may be solved simultaneously, thus further reducing the overall computation time. Each sub-problem may be solved by applying one or more combinatorial methods, e.g., neighborhood search-based methods. Each iteration concludes by appending the solutions of respective sub-problems to the principal problem, thus initiating a new iteration of the workflow or terminating the workflow if the desired quality of the schedule is reached, as described in more detail herein below.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or any combination thereof.

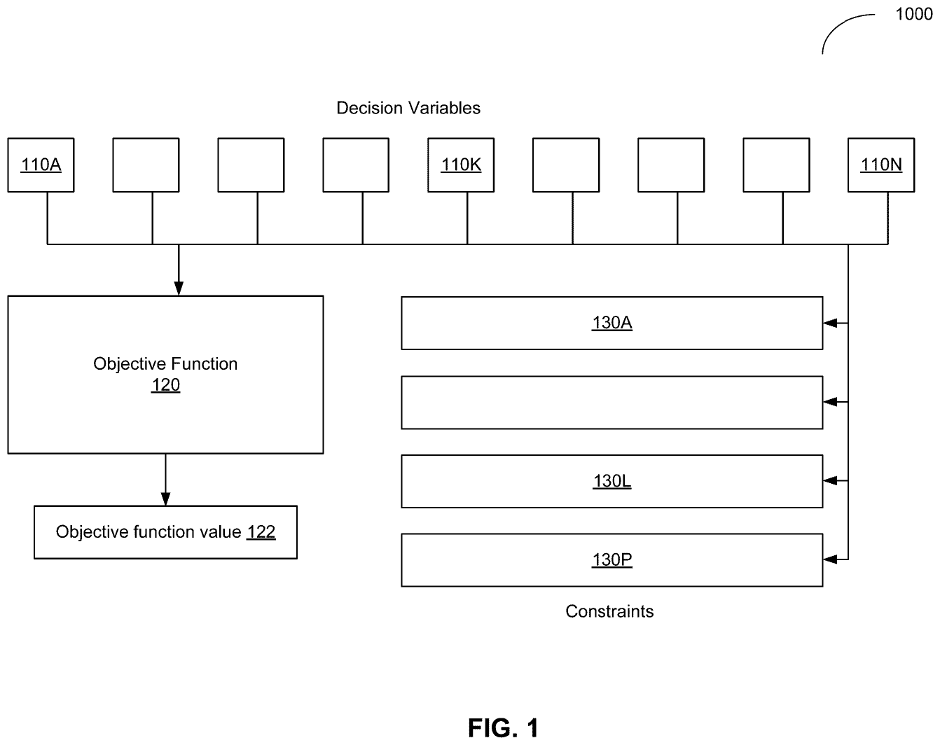

FIG. 1 schematically illustrates an example scheduling problem represented in a form solvable by the systems and methods of the present disclosure. As noted herein above, the example scheduling problem may be represented as a mixed integer linear programming (MILP) problem, which is formally defined as follows:

Minimize z=c^{T} x subject to Ax=b, x≥0, x∈ [symbol] ⁿ for at least some xᵢ.

Thus, as schematically illustrated by FIG. 1, the scheduling problem 1000 optimizes the objective function value 122 of the objective function 120 subject to the constraints 130A-130P. Both the objective function 120 and constraints 130A-130P are defined on a set of decision variables xᵢⱼ 110A-110N.

The decision variables 110A-110N may represent worker assignments to particular jobs in a given schedule. In an illustrative example, one or more decision variables may be represented by respective Boolean values (e.g., indicating whether a particular worker is assigned to work during a particular shift). In another illustrative example, one or more decision variables may be represented by respective integer values (e.g., the number of workers assigned to perform a particular job during a particular shift, the number of workers assigned to perform any work during a particular shift, the number of workers starting work during a particular period of time, the number of workers finishing work during a particular period of time, the number of occurrences of a particular event during a certain time period for a particular worker—such as the number of working nights, the number of consecutive working nights, the number of working weekends, the number of consecutive working weekends, the number of occurrences of more than a predefined number of consecutive working nights, etc.).

As noted herein above, the scheduling process is governed by various scheduling rules of different nature, scope, imperativeness, authority, etc. Sources of the scheduling rules may include applicable laws, regulations, policies, contracts, customary business practices, etc. Accordingly, while some of the rules may be translated to “soft” constraints that are represented by respective additive terms of the objective function, while other rules may be translated into “hard” constraints.

Thus, the objective function may reflect the overall quality of the schedule and may be composed by a set of additive terms representing respective soft constraints. In some implementations, these additive terms may be weighted by a set of coefficients reflecting their respective importance levels.

In some implementations, one or more “soft constraints” may be related to job coverage, which may be defined by the share of all the shift and job combinations that have been “covered,” i.e., assigned). Accordingly, one or more job coverage rules may require at least respective specified levels of job coverage to be achieved for specified jobs (or job categories) during various periods of time. In an illustrative example, the job coverage rules may require that the full (100%) job coverage for mission critical jobs be provided at all times; at least a first predefined level below the full coverage (e.g., 90%) job coverage be provided for essential jobs during high demand periods and at least a second predefined level below the first predefined level (e.g., 80%) job coverage be provided for essential jobs outside of high demand periods; and at least a third predefined level below the first predefined level (e.g., 75%) job coverage be provided for non-essential jobs at all times. These rules may be translated into respective additive terms of the objective function, such that each additive term would reflect the difference between the requisite job coverage and the actual job coverage achieved by the schedule for a particular category of jobs during a particular time period. These additive terms may be weighted by a set of coefficients reflecting the job category (e.g., the highest weight coefficient may be applied to mission critical jobs, the next highest weight coefficient may be applied to essential jobs, and the lowest weight coefficient may be applied to other jobs) and/or the demand aspect (e.g., the highest weight coefficient may be applied during the high demand periods while the lowest weight coefficient may be applied outside of high demand periods).

One or more “soft constraints” may be related to the worker satisfaction. Accordingly, the job satisfaction, measurable by one or more job satisfaction metrics, may be reflected by one or more additive terms of the objective function, such that each additive term would affect the value of the objective function proportionally to the deviation, from the desired value, of a metric characterizing the respective worker satisfaction aspect. In an illustrative example, a worker satisfaction metric may reflect the deviation between the worker's desired number of hours and the scheduled number of hours during a particular time period. In another illustrative example, a worker satisfaction metric may reflect the share of the total number of scheduled shifts for the worker that fall within the worker preferred time windows. In another illustrative example, a worker satisfaction metric may reflect a number of non-consecutive days off scheduled for the worker during a particular time period. In some implementations, one or more worker satisfaction metrics may be weighted by a set of coefficients reflecting respective worker seniorities.

One or more “soft constraints” may be related to the budgetary aspects of the schedule. Accordingly, the economic efficiency of the schedule, measurable by one or more economic efficiency metrics, may be reflected by one or more additive terms of the objective function, such that each additive term would affect the value of the objective function proportionally to the deviation, from the desired value, of a metric characterizing the respective economic efficiency aspect. In an illustrative example, an economic efficiency metric may reflect the increase in the total labor cost due to scheduled overtime shifts (which attract additional payments to the workers). In another illustrative example, an economic efficiency metric may reflect the costs of transporting one or more workers to their respective scheduled job placements outside of their regular geographic area. In another illustrative example, an economic efficiency metric may reflect the costs of scheduling overqualified workers to respective one or more jobs.

One or more “soft constraints” may be related to various other metrics characterizing various aspects of the schedule. Each aspect may be reflected by a respective additive term of the objective function, such that each additive term would affect the value of the objective function proportionally to the deviation, from the desired value, of a metric characterizing the respective aspect of the schedule. In an illustrative example, a schedule stability metric may reflect the difference between the current schedule and a schedule for a past period. In another illustrative example, a schedule alignment metric may reflect the difference between shift start times for a particular worker. In another illustrative example, an open shift distribution metric alignment metric may reflect the difference between the scheduled and the desired distribution of open shifts.

As noted herein above, certain scheduling rules may be translated into “hard” constraints of the scheduling problem. In an illustrative example, a subset of scheduling rules may specify skills, qualifications, and/or certifications that are necessary for performing certain jobs. In another illustrative example, a subset of scheduling rules may regulate the worked hours, time of day, time off, holidays, mandatory breaks, mandatory rest, etc. In another illustrative example, a subset of scheduling rules may establish the job priorities, e.g., requiring that job A be always chosen over job B if the two jobs compete for a single resource. In another illustrative example, a subset of scheduling rules may establish the worker priorities, e.g., based on their respective seniority. In another illustrative example, a subset of scheduling rules may prescribe the maximum number of consecutive working days, maximum number of working nights per week, maximum number of consecutive working nights, etc. In another illustrative example, a subset of scheduling rules may regulate various aspects of work performed by minors and/or other protected categories. Accordingly, these and various other scheduling rules may be translated into respective one or more constraints 130A-130P, which must be complied with by a valid solution of the scheduling problem 1000.

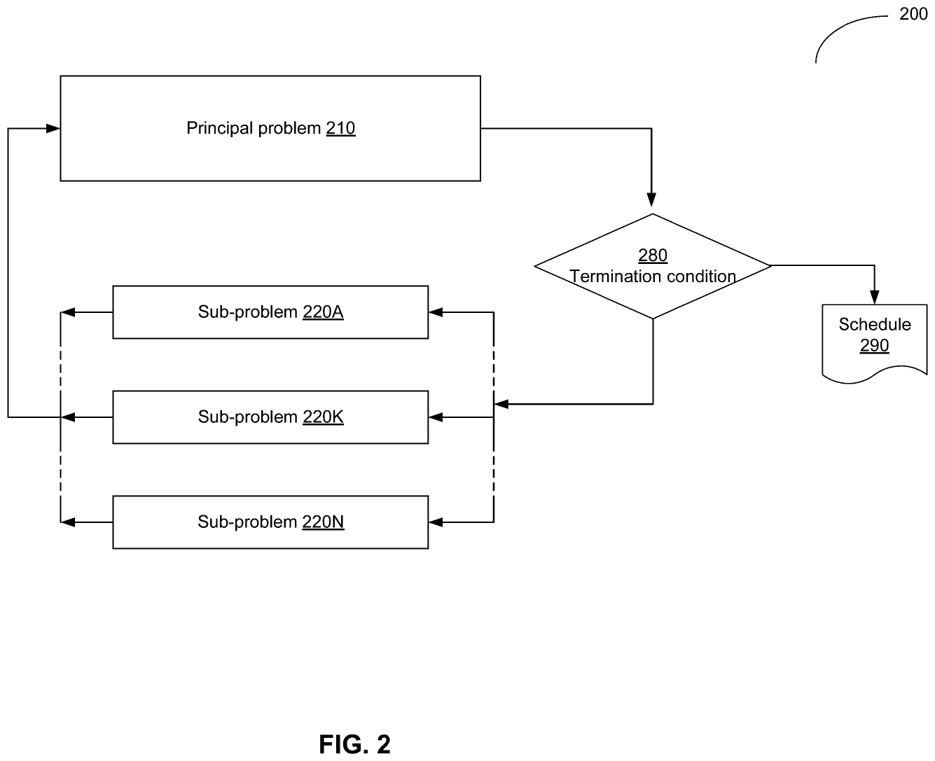

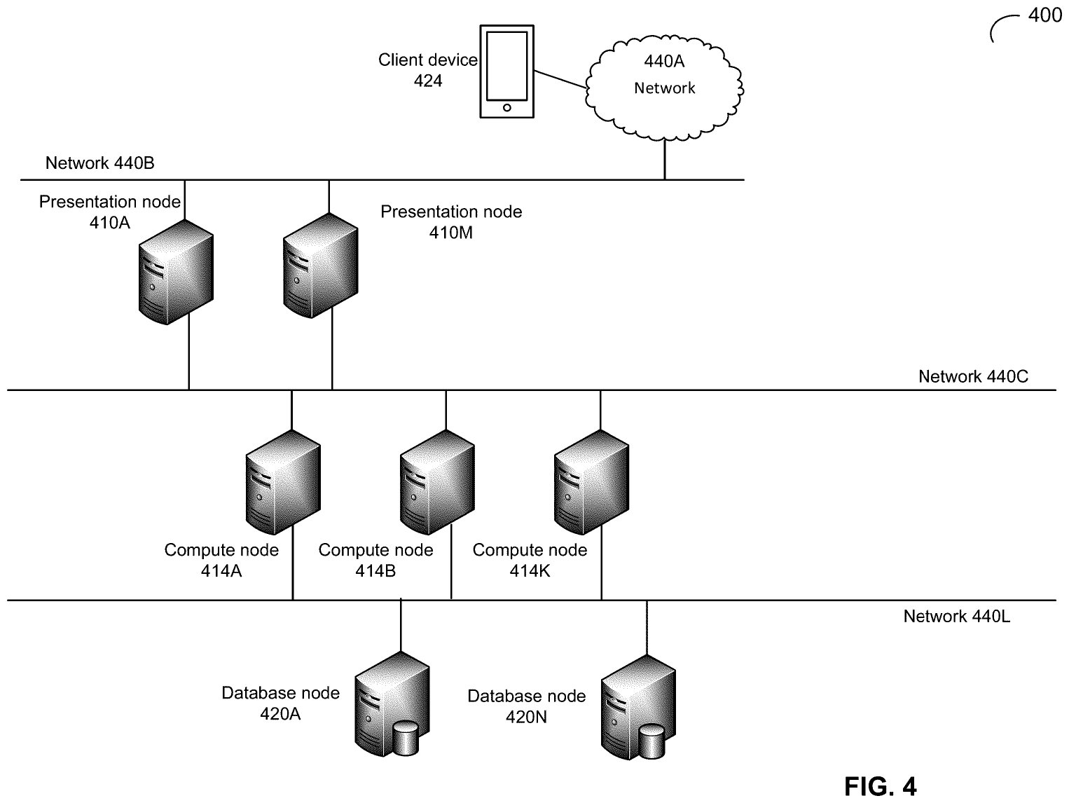

Thus, as noted herein above, the scheduling problem 1000 optimizes the objective function value 122 of the objective function 120 subject to the constraints 130A-130P. In order to reduce the computational complexity of solving the scheduling problem 1000, it may be broken down into the principal problem and a set of sub-problems, as schematically illustrated by FIG. 2, which depicts a flow diagram of an example workflow 200 of solving a workforce scheduling problem by decomposition, in accordance with aspects of the present disclosure. The workflow 200 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the workflow 200 is performed by the one or more execution environments (e.g., nodes 410, 414, 420 of FIG. 4), including one or more processes, processing threads, virtual or physical machines. In some implementations, the workflow 200 may be performed by a single execution environment. Alternatively, the workflow 200 may be performed by two or more execution environments, such that each execution environment may perform one or more individual functions, routines, subroutines, or operations of the workflow. In an illustrative example, the execution environments implementing the workflow 200 may be synchronized (e.g., using messages, semaphores, critical sections, and/or other synchronization mechanisms). Alternatively, the execution environments implementing the workflow 200 may be executed asynchronously with respect to each other. Although shown in a particular sequence or order, unless otherwise specified, the order of the operations may be modified. Some operations may be performed in parallel. Additionally, one or more operations may be omitted in some implementations. Thus, not all illustrated operations are required in every implementation, and other process flows are possible.

In the illustrative example of FIG. 2, the original scheduling problem may be broken down into the principal problem and a set of sub-problems 220A-220N. The principal problem 210 is defined on a subset of decision variables of the original scheduling problem. In some implementations, the subset of decision variables associated with the principal problem may be formed by decision variables representing respective worker schedules, for at least a subset of workers. The subset of constraints for the principal problem 200 may be formed by global constraints, i.e., the constraints that are applicable to all workers and/or all shifts being scheduled. Examples of such global constraints include job coverage, worker seniority, job priority, etc. The objective function of the principal problem may be constructed by removing, from the objective function of the original scheduling problem, the decision variables that are not included into the subset of decision variables of the principal problem.

The initial solution of the principal problem may be generated based on a set of historical shifts adjusted for the current demand. Due to its reduced (as compared to the original scheduling problem) dimensionality, the principal problem 210 may, at each iteration of the workflow 200, be solved as a MILP problem, e.g., by applying one or more mathematical programming techniques.

At each iteration, the solution of the principal problem 210 may be analyzed to identify one or more sub-schedules to be improved by respective one or more sub-problems 220A-220N.

In some implementations, one or more suboptimalities, represented by one or more global constraints and objectives that are not satisfied by the initial or intermediate solution of the principal problem, may be identified in the current solution. In various illustrative examples, a suboptimality could be an under- or over-coverage of a workload during a given period, or a worker having a higher seniority being less satisfied—in terms of the specified worker preferences—as compared to another worker having a lower seniority, or work hours not being equally assigned to workers, etc.

In an illustrative example, a subproblem may be restricted to one or more chosen workers to determine the schedules that are specific to that worker and improve the quality of the current overall schedule. A sub-problem may be further restricted to the workers whose schedules are likely to be modified to address a specific subset of most critical suboptimalities. Thus, a sub-problem may be defined with respect to at least a subset of workers, while focusing on a specified subset of constraints suboptimalities.

To limit the scope and accelerate the resolution of the sub-problems, a minimum cost (e.g., represented by the value of the objective function) assignment problem may be defined to assign the suboptimalities to respective workers. The assignment problem may be resolved in a polynomial time algorithm, e.g., by using a minimum-flow-based algorithm. The cost of the assignment of a suboptimality to a worker may be defined relative to the time between the start or end of the shift and the under- or over-coverage period if the suboptimality concerns workload coverage. The optimization of the sub-problem may then be limited to only the preassigned subset of suboptimalities.

In order to diversify the generated worker schedules while focusing on those likely to reduce the total cost (i.e., the overall value of the objective function) and obtain global schedules of a satisfactory quality, the reduced costs of the linear relaxation of the principal problem may be leveraged to guide the schedule generation. In an illustrative example, parts (or sub-schedules) from different worker schedules could be concatenated together into new valid schedules while minimizing the total reduced cost.

In some implementations, each sub-problem 220K may be defined by identifying, within the current solution of the principal problem 210, a sub-schedule that exhibits unsatisfactory quality (e.g., if a value of a chosen quality metric exhibited by the sub-schedule exceeds, by at least a predefined threshold value, a desired value). The chosen quality metric to be applied for selecting the sub-schedule may be represented by at least a subset of additive terms of the objective function of the principal problem, from which the decision variables are removed that are not relevant for the chosen grouping of scheduled shifts.

Thus, each sub-problem 220K is defined, e.g., by identifying, within the current solution of the principal problem, one or more suboptimalities, represented by one or more global constraints and objectives that are not satisfied by the initial or intermediate solution of the principal problem, may be identified in the current solution. Examples of such constraints include worker-centric scheduling rules, worker preferences, worker schedule stability, etc. For each sub-problem 220K, a corresponding subset of constraints may be formed by the local or individual constrains, i.e., the constraints that are only relevant to the identified suboptimalities assigned to sub-problem 220K. Examples of such constraints include worker-centric scheduling rules, worker preferences, worker schedule stability, etc.

The sub-problems 220A-220N may be solved simultaneously (e.g., by assigning a respective dedicated processing thread or an execution environment, such as a virtual or physical machine, to each of the sub-problems), thus further reducing the overall computation time.

Each sub-problem 220K may be solved by applying one or more combinatorial methods, e.g., local neighborhood search-based methods. A local neighborhood search-based method starts with an initial tentative solution of the sub-problem 220K, which may be generated by applying one or more mathematical programming methods and/or heuristics, e.g., by randomly choosing a point among all points satisfying the constraints. At each iteration of the search-based method, the values of decision variables are modified within a pre-defined vicinity of the current tentative solution in accordance with a chosen search strategy. In an illustrative example, the search strategy may call for introducing a minor modification into the sub-schedule (e.g., increasing or decreasing a scheduled shift by a small period of time, such as one hour; moving the start of a scheduled shift by a small period of time, such as one hour; or swapping two scheduled shifts) in an attempt to improve the value of the objective function. The point that exhibits a better value of the objective function of the sub-problem 220K while satisfying the constraints of the sub-problem 220K may then be chosen as the new tentative solution of the sub-problem 220K. The iterations may continue until the current solution may no longer be improved or a predefined termination condition for the sub-problem 220K is satisfied (e.g., a predefined threshold number of iterations have been performed), at which point the current tentative solution becomes the final solution of the sub-problem 220K.

Thus, the solution of the sub-problem 220K identifies one or more candidate decision variables that, if appended to the principal problem, would improve the value of the principal objective function as compared to its current value.

Each iteration of the workflow 200 concludes by appending the solutions of respective sub-problems 220A-220N to the principal problem 210, thus initiating a new iteration of the workflow 200 or terminating the workflow if the workflow termination condition 280 is satisfied (e.g., the desired quality of the schedule measured by the value of the objective function of the principal problem 210 is reached or a predefined threshold number of workflow iterations have been performed). Upon terminating the workflow 200, the schedule 290 is generated based on then current solution of the principal problem 210.

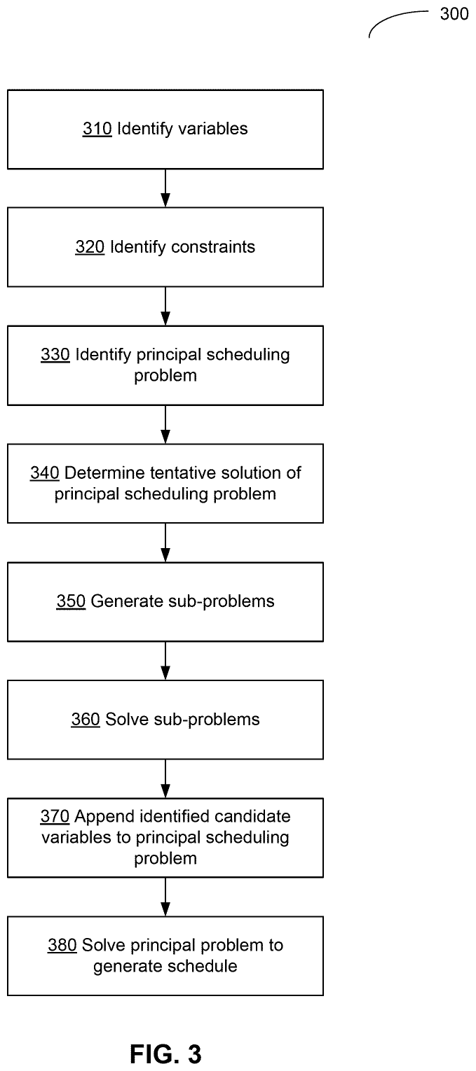

FIG. 3 depicts a flow diagram of an example method of generating a workforce schedule by decomposition of the original scheduling problem, in accordance with aspects of the present disclosure. The method 300 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the method 300 is performed by the one or more execution environments (e.g., nodes 410, 414, 420 of FIG. 4), including one or more processes, processing threads, virtual or physical machines. In some implementations, the method 300 may be performed by a single execution environment. Alternatively, the method 300 may be performed by two or more execution environments, such that each execution environment may perform one or more individual functions, routines, subroutines, or operations of the method. In an illustrative example, the execution environments implementing the method 300 may be synchronized (e.g., using messages, semaphores, critical sections, and/or other synchronization mechanisms). Alternatively, the execution environments implementing the method 300 may be executed asynchronously with respect to each other. Although shown in a particular sequence or order, unless otherwise specified, the order of the operations may be modified. Some operations may be performed in parallel. Additionally, one or more operations may be omitted in some implementations. Thus, not all illustrated operations are required in every implementation, and other process flows are possible.

At operation 310, the processing logic implementing the method identifies a plurality of variables associated with scheduling a plurality of workers to perform a plurality of jobs during a plurality of time periods, as described in more detail herein above. Alternatively, the processing logic may generate the variables by analyzing historical schedules and/or pertinent scheduling rules.

At operation 320, the processing logic identifies a plurality of constraints associated with the plurality of variables, as described in more detail herein above. In some implementations, the processing logic may receive descriptions of the constraints via a graphical user interface (GUI) or an application programming interface (API). Alternatively, the processing logic may generate the constraints by analyzing the pertinent scheduling rules.

At operation 330, the processing logic identifies a principal scheduling problem for optimizing a principal objective function defined on a principal subset of the plurality of variables subject to a principal subset of the plurality of constraints. Each variable of the principal subset may be associated with a worker schedule (which is a sub-schedule of the overall schedule to be generated) of a corresponding worker. The principal objective function may reflect a chosen quality metric associated with the worker schedule. The principal subset of constraints may specify global constraints associated with each variable of the principal subset of the plurality of variables, as described in more detail herein above. In some implementations, the processing logic may generate a definition of the principal scheduling problem by analyzing historical schedules and/or pertinent scheduling rules.

At operation 340, the processing logic determines a tentative solution of the principal scheduling problem. In some implementations, the tentative solution of the principal scheduling problem may be determined by applying mixed integer linear programming (MILP) methods, as described herein above.

At operation 350, the processing logic generates one or more sub-problems, such that each sub-problem optimizes a respective objective function. Each sub-problem may be generated responsive to identifying a corresponding sub-schedule of the tentative solution of the principal problem, such that the value of a chosen quality metric of the corresponding sub-schedule would exceeds a predefined threshold value, as described in more detail herein above.

At operation 360, the processing logic solves the sub-problems. Solving each sub-problem may involve performing a neighborhood search in a vicinity of a known solution of the sub-problem. Each sub-problem may be solved by a respective dedicated execution environment (e.g., a processing thread, a physical server, or a virtual machine). Solution of each sub-problem may identify one or more candidate variables that improve the value of the principal objective function, as described in more detail herein above.

At operation 370, the processing logic modifies the principal scheduling problem by appending the identified candidate variables to the principal scheduling problem, as described in more detail herein above.

At operation 380, the processing logic generates, by solving the modified principal scheduling problem, a schedule to assign the plurality of workers to perform the plurality of jobs during the plurality of time periods.

An example mathematical model for the principal problem is described below. In the following description:
e denotes a worker in the optimization scope;
s denotes a valid worker schedule which may include a series of shifts and/or days off over the scheduling period;
the validity concerns all worker's individual schedule rules (e.g., qualification, minimum rest between shifts, min/max hours per period, etc.);
a schedule may be represented by a column of a rectangular matrix; the set of schedules may be updated iteratively after each “column generation” iteration and are obtained by solving the column generation sub-problem;
r denotes a rule that applies to at least a subset of the worker schedules; examples of a rule include a requirement instant coverage, a budget limit, grouped arrivals, equity factor across a group of prioritized workers regarding one or several preferences, etc.

The variables are defined as follows:

$${x}_{s} = \{ \begin{matrix}1 & if schedule s is selected to be part of the global schedule \\ 0 & otherwise\end{matrix}$$

The constraints are defined as follows:
Σ_{s∈S}_{^{e}} xₛ=1; for each worker e, where:
S^{e}: Set of valid schedules of worker e.

These constraints state that each worker should have a schedule.

ΣₑΣ_{s∈S}_{^{e}} αₛ^{tn}xₛ [symbol] f(n, t); for each requirement n and each period t, where:

$${α}_{s}^{t n} = \{ \begin{matrix}1 & if s is a schedule covering the requirement n at t \\ 0 & otherwise\end{matrix}$$

f(n, t): demand headcount for requirement n and period t
[symbol] indicates the possible control of the left-hand-side in the objective function through the penalization variables or hard bounds.

These constraints set the “control” of the over/under coverage for each time subdivision and for each requirement.
ΣₑΣ_{s∈S}_{^{e}} βₓ^{r}xₛ [symbol] f(r); for each scheduling global rule r, where:
βₛ^{r}: contribution of schedule s to scheduling rule r
f(r): right hand side of rule r

These constraints set the “control” of the scheduling global rules, by accumulating worker schedule credits over a specified time window. They may correspond to worked hours, payroll, worker satisfaction, etc.

The objective function to be minimized represents the sum of all penalties associated with the penalization variables used to control the different scheduling rules and objectives.

FIG. 4 schematically illustrates a high-level diagram of an example distributed computer system 400, which may implement the methods described herein. Nodes, appliances, and network segments are shown in FIG. 4 for illustrative purposes only and do not in any way limit the scope of the present disclosure. Various other nodes, components, appliances, and/or methods of their interconnection may be compatible with the methods and systems described herein. Firewalls, load balancers, network switches and various other networking components may be omitted from FIG. 4 for clarity and conciseness.

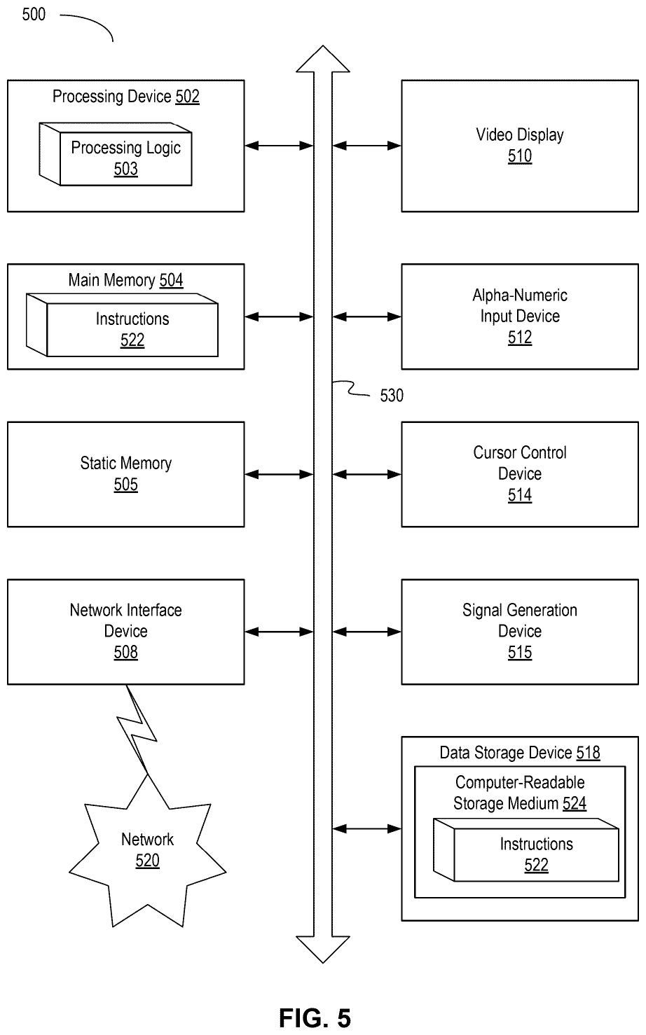

Each node in FIG. 4 may represent an isolated or shared execution environment, such as a virtual machine or a physical server. The functional designation of nodes in FIG. 4 does not necessarily corresponds to the physical boundaries between corresponding environments, e.g., the same physical server may perform the functions of one or more compute nodes, one or more database nodes, and/or one or more presentations nodes. In another illustrative example, the functions of each node of FIG. 4 are performed by a dedicated physical server. In another illustrative example, the functions of each node of FIG. 4 are performed by a dedicated virtual machine (e.g., operating in a private, public, or hybrid cloud environment). In some implementations, one or more nodes of FIG. 4 may be implemented by example computer system 500 of FIG. 5.

The example distributed computer system 400 may include one or more presentation nodes 410A-410M, compute nodes 414A-414K, database nodes 420A-420N, and/or various other nodes interconnected by one or more networks 440A-440L. The networks 440A-440L may be represented by one or more private networks and/or one or more public networks, including wired, wireless, and/or virtual networks.

The compute nodes 414A-414K perform the scheduling methods described herein. The compute nodes 414A-414K may access database nodes 420A-420N for retrieving the information to be used for solving the scheduling problems (e.g., organizational structure, historic schedules, scheduling rules, and/or various other information). The schedules produced by compute nodes 414A-414K may also be stored on database nodes 420A-420N.

In some implementations, the schedules produced by compute nodes 414A-414K may be supplied to the presentation nodes 410A-410M, which may convert the schedules into a representation (e.g., HTML-based representation) that may be rendered by one or more client devices 424. Each client device 424 may be represented, e.g., by a laptop, a desktop computer, a smartphone, a tablet, or other mobile or stationary computing device. In some implementations, the client devices may be employed for supplying, to the compute nodes 414A-414K, various information that may be utilized for computing the schedules (e.g., updates to organizational structure, scheduling rules, worker availability, etc.).

The above-described architecture of the example distributed computer system 400 serves as an illustrative example only and does not in any way limit the scope of the present disclosure. References herein to presentation nodes, compute nodes, database nodes, and/or other components of example distributed computer systems are purely functional, as a single hardware system or a single software component may implement functions of one or more functional components that are described or referenced herein. Various other system architectures may be compatible with the methods and systems implemented in accordance with one or more aspects of the present disclosure.

FIG. 5 depicts an example computer system 500 that may perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 505 (e.g., flash memory, static random access memory (SRAM)), and a data storage device 518, which communicate with each other via a bus 530.

Processing device 502 (which may include processing logic 503) represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 522 for implementing the methods described herein (e.g., methods 200, 300).

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one illustrative example, the video display unit 510, the alphanumeric input device 512, and the cursor control device 514 may be combined into a single component or device (e.g., an LCD touch screen).

The data storage device 518 may include a computer-readable storage medium 524 on which is stored the instructions 522 embodying any one or more of the methodologies or functions described herein. The instructions 522 may also reside, completely or at least partially, within the main memory 504 and/or within the processing device 502 during execution thereof by the computer system 500, the main memory 504 and the processing device 502 also constituting computer-readable media. In some implementations, the instructions 522 may further be transmitted or received over a network 520 via the network interface device 508.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
identifying, by a processing device, a plurality of variables associated with scheduling a plurality of workers to perform a plurality of jobs during a plurality of time periods;
identifying a plurality of constraints associated with the plurality of variables;
identifying a principal scheduling problem for optimizing a principal objective function defined on a principal subset of a plurality of variables subject to a principal subset of the plurality of constraints, wherein each variable of the principal subset is associated with a worker schedule of a corresponding worker;
determining a tentative solution of the principal scheduling problem;
identifying one or more sub-problems, each sub-problem associated with a subset of constraints that are not satisfied by a tentative schedule defined by the tentative solution;
identifying, by solving the one or more sub-problems, one or more candidate variables improving a value of the principal objective function;
modifying the principal scheduling problem by appending the one or more candidate variables to the principal scheduling problem; and
generating, by solving the modified principal scheduling problem, a schedule to assign at least the plurality of workers to perform at least the plurality of jobs during at least the plurality of time periods.

2. The method of claim 1, wherein the schedule is represented by a finite set of n-tuples, each n-tuple specifying at least one of: a shift identifier, a job identifier, or a worker identifier.

3. The method of claim 1, wherein the principal objective function reflects a chosen quality metric associated with the schedule.

4. The method of claim 1, wherein the principal subset of the plurality of constraints specifies global constraints.

5. The method of claim 1, wherein solving the sub-problem further comprises:
performing neighborhood search in a vicinity of a known solution of the principal problem.

6. The method of claim 1, wherein each sub-problem of the one or more sub-problems is generated responsive to identifying a corresponding sub-schedule of the tentative solution of the principal problem, wherein a value of a chosen quality metric of the corresponding sub-schedule exceeds a predefined threshold value.

7. The method of claim 1, wherein each sub-problem of the one or more sub-problems is solved by a dedicated execution environment provided by one of: a processing thread, a physical server, or a virtual machine.

8. A system, comprising:
a memory; and
a processing device coupled to the memory, the processing device configured to:
identify a plurality of variables associated with scheduling a plurality of workers to perform a plurality of jobs during a plurality of time periods;
identify a plurality of constraints associated with the plurality of variables;
identify a principal scheduling problem for optimizing a principal objective function defined on a principal subset of a plurality of variables subject to a principal subset of the plurality of constraints, wherein each variable of the principal subset is associated with a sub-schedule of a corresponding worker;
determine a tentative solution of the principal scheduling problem;
identify one or more sub-problems, each sub-problem associated with a subset of constraints that are not satisfied by a tentative schedule defined by the tentative solution;
identify, by solving the one or more sub-problems, one or more candidate variables improving a value of the principal objective function;
modify the principal scheduling problem by appending the one or more candidate variables to the principal scheduling problem; and
generate, by solving the modified principal scheduling problem, a schedule to assign at least the plurality of workers to perform at least the plurality of jobs during at least the plurality of time periods.

9. The system of claim 8, wherein the schedule is represented by a finite set of n-tuples, each n-tuple specifying at least one of: a shift identifier, a job identifier, or a worker identifier.

10. The system of claim 8, wherein the principal objective function reflects a chosen quality metric associated with the schedule.

11. The system of claim 8, wherein the principal subset of the plurality of constraints specifies global constraints associated with each variable of the principal subset of the plurality of variables.

12. The system of claim 8, wherein solving the sub-problem further comprises:
performing neighborhood search in a vicinity of a known solution of the sub-problem.

13. The system of claim 8, wherein each sub-problem of the one or more sub-problems is generated responsive to identifying a corresponding sub-schedule of the tentative solution of the principal problem, wherein a value of a chosen quality metric of the corresponding sub-schedule exceeds a predefined threshold value.

14. The system of claim 8, wherein each sub-problem of the one or more sub-problems is solved by a dedicated execution environment provided by one of: a processing thread, a physical server, or a virtual machine.

15. A computer-readable non-transitory storage medium comprising executable instructions that, when executed by a processing device, cause the processing device to:
identify a plurality of variables associated with scheduling a plurality of workers to perform a plurality of jobs during a plurality of time periods;
identify a plurality of constraints associated with the plurality of variables;
identify a principal scheduling problem for optimizing a principal objective function defined on a principal subset of a plurality of variables subject to a principal subset of the plurality of constraints, wherein each variable of the principal subset is associated with a worker schedule of a corresponding worker;
determine a tentative solution of the principal scheduling problem;
identify one or more sub-problems, each sub-problem associated with a subset of constraints that are not satisfied by a tentative schedule defined by the tentative solution;
identify, by solving the one or more sub-problems, one or more candidate variables improving a value of the principal objective function;
modify the principal scheduling problem by appending the one or more candidate variables to the principal scheduling problem; and
generate, by solving the modified principal scheduling problem, a schedule to assign at least the plurality of workers to perform at least the plurality of jobs during at least the plurality of time periods.

16. The computer-readable non-transitory storage medium of claim 15, wherein the schedule is represented by a finite set of n-tuples, each n-tuple specifying at least one of: a shift identifier, a job identifier, or a worker identifier.

17. The computer-readable non-transitory storage medium of claim 15, wherein the principal objective function reflects a chosen quality metric associated with the schedule.

18. The computer-readable non-transitory storage medium of claim 15, wherein the principal subset of the plurality of constraints specifies global constraints associated with each variable of the principal subset of the plurality of variables.

19. The computer-readable non-transitory storage medium of claim 15, wherein solving the sub-problem further comprises:
performing neighborhood search in a vicinity of a known solution of the sub-problem.

20. The computer-readable non-transitory storage medium of claim 15, wherein each sub-problem of the one or more sub-problems is generated responsive to identifying a corresponding sub-schedule of the tentative solution of the principal problem, wherein a value of a chosen quality metric of the corresponding sub-schedule exceeds a predefined threshold value.
